(19) United States
(12) Patent Application Publication
(10) Pub. No.: US 2017/0259307 A1
(43) Pub. Date: Sep. 14, 2017

(54) Mat Washing System

(71) Applicant: Northern Mat & Bridge (GP) LTD., Calgary (CA)

(72) Inventors: Darren Francis, Alberta (CA); Scott Henderson, AB (CA); Carson Kowal, AB (CA); Collin Wood, AB (CA); Jerome W. Cupido, AB (CA); Jeremy VANDERGAAG, AB (CA); Scott Vyse, AB (CA)

(73) Assignee: Northern Mat & Bridge (GP) Ltd., Calgary, AB (CA)

(21) Appl. No.: 15/526,063

(22) PCT Filed: Nov. 10, 2015
(86) PCT No.: PCT/CA2015/000570

§ 371 Date: May 11, 2017

(30) Foreign Application Priority Data
Nov. 14, 2014 (CA) 2,871,376

(51) Int. Cl. B08B 1/02; B08B 1/00; B08B 3/02; B08B 1/04

(52) U.S. Cl. CPC B08B 1/02; B08B 1/04; B08B 1/002; B08B 3/022

(57) ABSTRACT

A system for washing a large flat object having a length and a width, wherein the length is of greater dimension than said width, said system comprising: a frame having a first and second end; a transport system adapted to vertically transport said large flat object suspended thereon; said transport system defining a horizontal axis along the device and adapted to transport said object from the first end of the frame to the second end of the frame; and at least one brushing means for brushing and removing particles lodged on said object; said at least one brushing means located along the transport system between the first and second end of the frame and adapted to frictionally engage said object when in operation.

### FIELD OF THE INVENTION

The present invention is generally directed to an industrial washing system for washing large flat objects, more specifically for washing large mats also referred to as access mats.

### BACKGROUND OF THE INVENTION

In order to facilitate transport and movement of heavy vehicles in construction areas and remote mining or oil and gas worksites, it is often desirable to have access roads or worksites covered with road mats also referred to as access mats. These allow vehicles to circulate on very difficult unpaved roads by reducing or even completely eliminating the risk of getting bogged down in mud. These mats are laid right over access roads to help the circulation of heavy equipment such as trucks, cranes and other heavy machinery. However, over time, the mats get covered in dirt and must be washed prior to being moved to another work site or being re-used. Manual washing of these mats is extremely time consuming and is a very inefficient process. The sheer number of mats to be washed is a barrier to washing such mats purely by human activity as it would become economically undesirable to do so.

Known devices for washing swamp mats, such as the one disclosed in U.S. Pat. No. 8,273,186, have a conveying system to transport the mats through the device on rollers. A multiplicity of rollers expose the system to the possibility of breakdowns as the dirt, dust may accumulate on the rollers and diminish their ability to operate optimally which can possibly results in delays and cost overruns.

Because the mats are made of horizontal and vertical boards, the boards may tend to jam in the slots between the rollers of the conveyor system.

The present invention is generally directed to an industrial washing device, more specifically to a device for washing mats, where the washing operation is controlled for the most part by a computerized control system.

Consequently, there still remains a reliable device which provides a method of washing mats which overcomes certain drawbacks of prior art devices.

### SUMMARY OF THE INVENTION

Accordingly, the present invention is generally directed to an industrial washing system, more specifically to a system for washing mats. According to one aspect of the present invention, there is provided a system for washing a large flat object having a length and a width, wherein the length is of greater dimension than said width, said system comprising:
a frame having a first and second end;
a transport system secured to the frame and adapted to vertically transport said large flat object suspended thereon; said transport system having a longitudinal frame member defining a horizontal axis along the device and adapted to transport said object from the first end of the frame to the second end of the frame; and
at least one brushing means for brushing and removing particles lodged on said object; said at least one brushing means located along the transport system between the first and second end of the frame and adapted to frictionally engage said object when in operation.

Preferably, the at least one brushing means comprises a variable resistance means adapted to impart variable pressure on the object. Preferably, the large flat object is hung from its side.

Preferably the system further comprises a loading support located at the first end of the frame, said loading support adapted to receive a plurality of objects to be washed. More preferably, the loading support further comprises an index to separate and lift the object from said support. Preferably also, the loading support is adapted to move from a horizontal position to a vertical position. Preferably, the loading support further comprises hydraulic cylinders to move said loading support from a horizontal position to a vertical position.

Preferably, the system further comprises an unloading support located at the second end of the frame to receive the washed object. In a preferred embodiment, the unloading support further comprises an index with a horizontally moving clamp. Preferably, the unloading support comprises an L-shaped frame pivotally movable about an axis to move from a substantially vertical position to a substantially horizontal position.

According to a preferred embodiment, the at least one brushing means is adapted to brush the entire height of the object. Preferably, the at least one brushing means is adapted to brush both sides of the large flat object simultaneously.

According to a preferred embodiment, the system further comprising at least one water source adapted to strike the object when such is being transported. Preferably, the at least one water source adapted to strike the object and said water source being located proximate before the at least one brushing means. Also preferably, the system further comprises a second brushing means which is a horizontally-shafted conical gutter brush. More preferably, the at least one brushing means is a fiber brush system comprising:
a. a vertical drum located on either side of the transport system horizontal axis, said vertical drum having brush fibers extending outwardly therefrom;
b. a lower bearing assembly engaging said vertical drum; and
c. a drive motor comprising an upper bearing assembly engaging said vertical drum;
   wherein said vertical drum being movable from a first position away from the horizontal axis defined by the longitudinal frame member of the transport system to a second position proximate the horizontal axis.

Preferably, the system further comprising at least one water source adapted to spray water on the object and said water source being located proximate the second end of the frame after the at least one brushing means. More preferably, the system further comprises at least one water source adapted to strike the object and said water source being located proximate the first end of the frame after the at least one brushing means. In a preferred embodiment, the system further comprises at least one water source adapted to spray water on the object and said water source being located proximate the first end of the frame before the at least one brushing means.

According to a preferred embodiment, the system further comprising at least one water collecting means to collect water used in washing the object. Preferably, the water collecting means is a trough located underneath the path of the object being washed and adapted to receive and collect the water dripping off the object. More preferably, the water collecting means further comprises a channel adapted to direct the collected water to a settling tank. According to a preferred embodiment, the system further comprises at least one water treatment means for treating the water collected by the collecting means.

According to a preferred embodiment, the transport system comprises:
a carriage member comprising at least one pair of gripping members adapted to grip the object and maintain it off the ground while the object is being transported from the first position to the second position; and
a linear roller bearing assembly mounted adapted to allow for the carriage member to move between a first position located at the first end of the frame and a second position located at the second end of the frame.

According to another aspect of the present invention, there is provided a system for washing a large flat object having a length and a width, wherein the length is of greater dimension than said width, said system comprising:
a frame having a first and second end;
a transport system adapted to vertically transport said large flat object suspended thereon; said transport system comprising a linear bearing assembly extending from the first end of the washing system to the second end of the washing system, said transport system adapted to transport said object from the first end of the frame to the second end of the frame; and
at least one brushing means adapted for brushing vertically said object; said at least one brushing means located underneath the linear bearing assembly along the transport system between the first and second end of the frame.

Preferably, the system further comprises a second brushing means adapted for brushing horizontally said object; said second brushing means is located underneath the longitudinal frame member of the transport system between the first and second end of the frame.

According to a preferred embodiment, the system is mounted on a tractor trailer.

According to another preferred embodiment, the system further comprises a closed loop water recirculation system. Preferably, the system further comprises a chemical spraying assembly to chemically treat the object to be washed, wherein said chemical spraying assembly is located after the washing chamber. More preferably, the system further comprises a separate chemical recovery system. Even more preferably, the separate chemical recovery system comprises a channel adapted to receive liquid dripping off the object. Preferably also, the separate chemical recovery system further comprises a chemical recovery vessel in fluid connection with said channel adapted to receive liquid dripping off the object.

According to a preferred embodiment, the system further comprising a tank supplying water and more preferably the water used in the washing process is recirculated into the tank which comprises a filtration system to remove suspended solids present in water prior to the water exiting the tank. Preferably, the filtration system is made up of a geotextile fabric.

According to another aspect of the present invention, there is provided a system for washing a large flat object having a length and a width, wherein the length is of greater dimension than said width, said system comprising:
a frame having a first and second end;
a transport system adapted to vertically transport said large flat object suspended thereon; said transport system defining a horizontal axis along the device and adapted to transport said object from the first end of the frame to the second end of the frame; and
a first and a second set of brushing means for brushing and removing particles lodged on said object; wherein said first and second set of brushing means are adapted to have a perpendicular brushing impact motion on the object with respect to the brushing impact caused by one another.

According to another aspect of the present invention, there is provided a Method for washing a mat, said method comprising:
a step of providing a mat;
a step of hanging a mat from a side thereof on a transport system;
a step of transporting the mat through at least one brushing means; and
a step of retrieving the mat and removing from the transport system.

According to a preferred embodiment, said method further comprises a water spraying step prior to the mat reaching said at least one brushing means.

### BRIEF DESCRIPTION OF THE FIGURES

The present invention may be better understood in consideration of the following description of various embodiments of the invention in connection with the accompanying drawings, in which:

FIG. 1 is a perspective view of the mat washing system according to a preferred embodiment of the present invention as carried on a work site by a tractor trailer.

FIG. 2 is a perspective view of the washing system according to a preferred embodiment of the present invention as set up on a work site.

FIG. 3 is a perspective view of the back of the washing system according to a preferred embodiment of the present invention as set up on a work site.

FIG. 4 is a perspective view of the washing system according to a preferred embodiment of the present invention as a mat is entering the washing section of the system.

FIG. 5 is a front view of the loading section, with mats loaded thereon, of the washing system according to a preferred embodiment of the present invention.

FIG. 6 is a side view of the washing section of the washing system according to a preferred embodiment of the present invention as a mat is leaving the washing section.

FIG. 7(A) is a front view of the loading section, without mats, of the washing system according to a preferred embodiment of the present invention.

FIG. 7(B) is a front view of the unloading section, with mat, of the washing system according to a preferred embodiment of the present invention.

FIG. 8 is a side view of the carriage member of the washing system according to a preferred embodiment of the present invention.

FIG. 9 is a close up view of the gripper assembly of the washing system according to a preferred embodiment of the present invention, where the gripper is clamping a mat.

FIG. 10 is a close up exposed view of the carriage member of the washing system according to a preferred embodiment of the present invention.

FIG. 11 is a side view of the transport system of the washing system according to a preferred embodiment of the present invention.

FIG. 12 is a front view of the transport system of the washing system according to a preferred embodiment of the present invention.

FIG. 13 is a side perspective view of the carriage member of the transport system of the washing system according to a preferred embodiment of the present invention.

FIG. 14 is a close up perspective view of the gripper assembly of the washing system according to a preferred embodiment of the present invention.

FIG. 15 is a top view of the gripper assembly of the washing system according to a preferred embodiment of the present invention.

FIG. 16 is a side view of the gripper assembly of the washing system according to a preferred embodiment of the present invention.

FIG. 17 is a front view of the gripper assembly of the washing system according to a preferred embodiment of the present invention.

FIG. 18 is a top view of the washing section of the washing system according to a preferred embodiment of the present invention.

FIG. 19 is a side view of the washing section of the washing system according to a preferred embodiment of the present invention.

FIG. 20 is a front view of the washing section of the washing system according to a preferred embodiment of the present invention.

FIG. 21 is a side perspective view of the unloading section of the washing system according to a preferred embodiment of the present invention.

FIG. 22 is a back view of the unloading section of the washing system according to a preferred embodiment of the present invention.

### DESCRIPTION OF PREFERRED EMBODIMENTS OF THE INVENTION

The system for washing large flat objects, according to a preferred embodiment of the present invention, is capable to be transported on a custom made trailer. The trailer follows highway transportation rules and is designed (weight) to be transported during a 75% Road Ban. Known devices are understood to be stationary systems once installed. The system for washing large flat objects, according to a preferred embodiment of the present invention must adhere to transportation guidelines, it does so by having one height for transportation and one height for operation. The operation height exceeds the transportation guidelines.

The system for washing large flat objects, according to a preferred embodiment of the present invention has a single vertical transport system. Known devices have several separate horizontal conveying systems that may work together to pass the mats to each other from the front end of the device to the back end.

According to yet another aspect of the invention, the mat washing device can be completely automated utilizing a programmable logic controller (PLC). The PLC allows for the mat washing machine to operate completely on its own once the mats are placed horizontally on the infeed stacker. This is an advantage over known devices as none have integrated complete automation capabilities.

The system to wash large flat objects according to a preferred embodiment of the present invention comprises a transport system; a washing section; a water supply and recirculation system; an object loading section and an object unloading section. Preferably, there is a section or a controller room where the system operation and monitoring is carried out. The water supply and recirculation system comprises a water tank capable of storing and providing water that has been trucked in for operations in a remote area. The water system further comprises a large channel located underneath the transport system in a position to recover water used in the process to wash the objects. The water captured in the channel is directed to a settling tank, in a preferred embodiment there are 6 settling chambers in total, where the dirt and other particulates are settled out and the water is further directed to a second settling tank which allows for further settling and clarifying of the water prior to it being filtered (optionally) and reintroduced in the water tank.

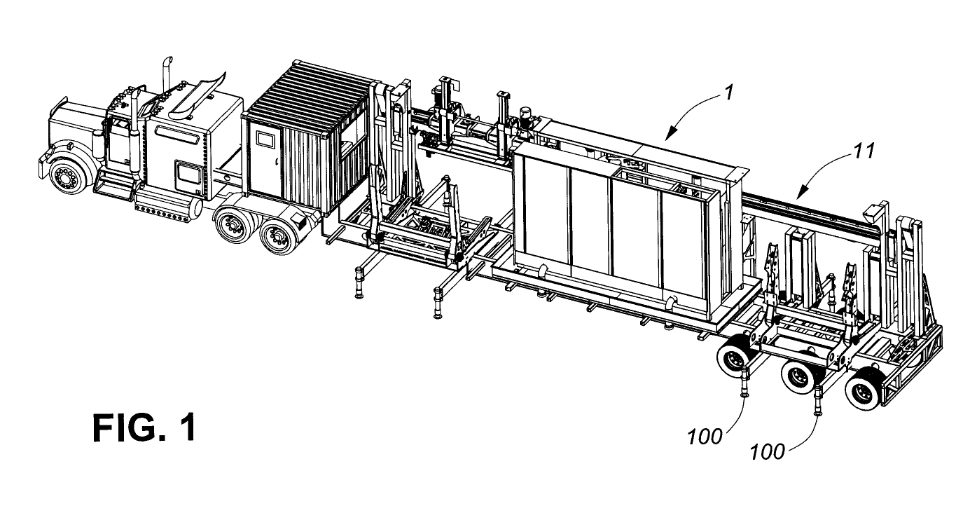

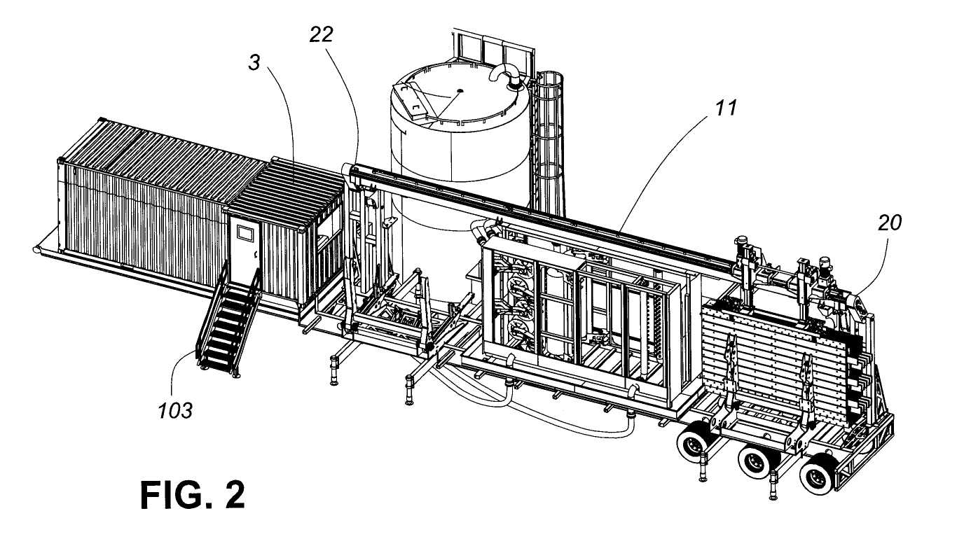

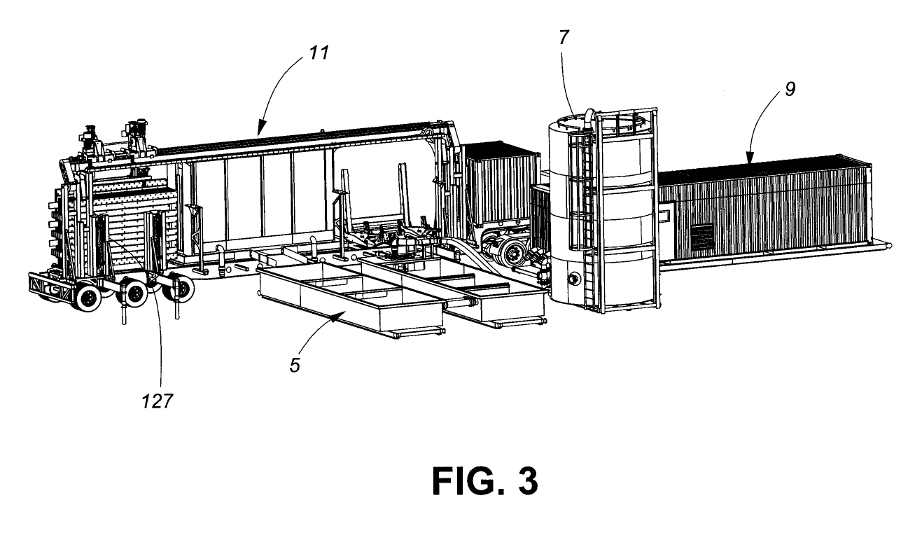

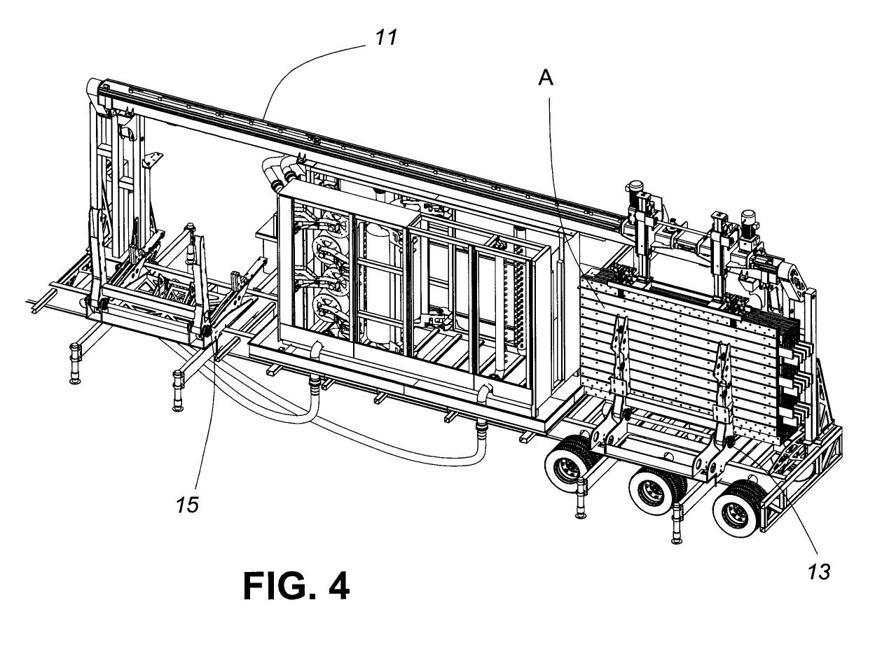

As seen in FIGS. 1, 2, 3 and 4, once arrived at the worksite, the washing system (1) is set in place by first positioning the main trailer at a desired location; subsequently outriggers (100) located on either side of the tractor trailer are extended and secured in place. The control room (3) stairs (103) are secured and the mud tanks (5), water supply tank (7), power house (9) are brought in and positioned. The hoses are hooked up to the tanks and the washing system (1). The linear bearing system (21) is lifted into place by a lift or crane from the stored position (see FIG. 1) to the working position (see FIGS. 2, 3 and 4). The tanks are filled with water.

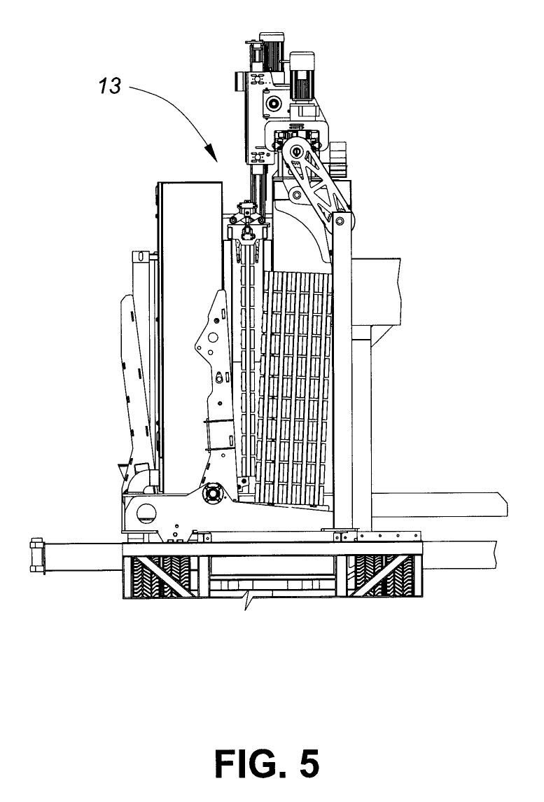

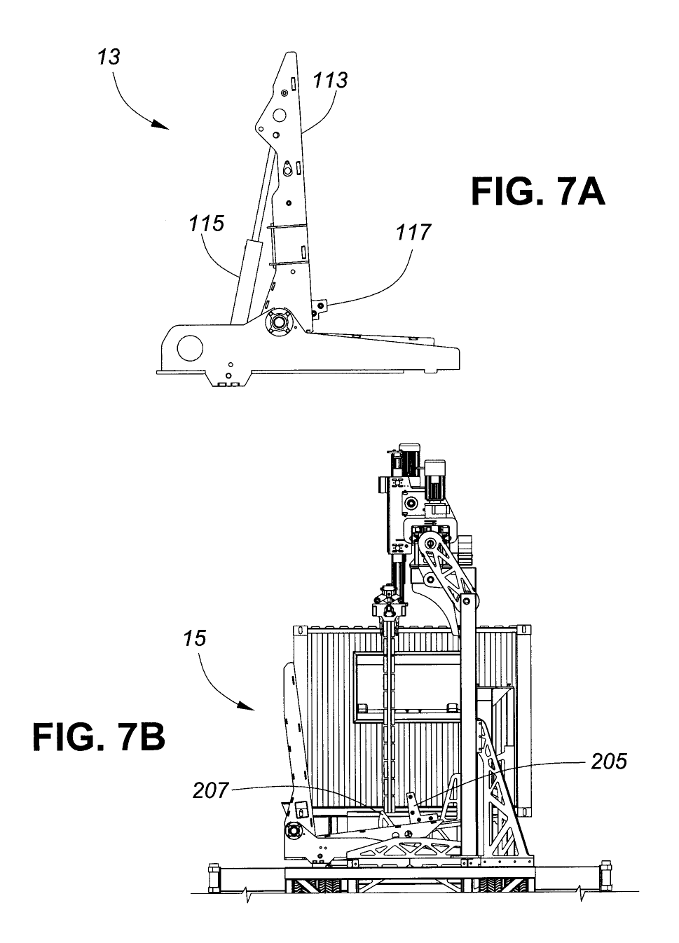

As best seen in FIGS. 5 and 7(A), the infeed system also referred to as the loading section (13) comprises a front end loader which can load 2 mats at a time to get up to 6 mats. The object-receiving surface (113) of the loading section (13) receives large flat objects such as mats which are place flat on their surface and after loading several mats, the object-receiving surface (113) is then lifted and tilted substantially vertically through the operation of large hydraulic cylinders (115). The large hydraulic cylinders are operatively connected to the object-receiving surface of the loading section. The programmable logic control system (PLC) causes a single mat to be lifted at any height necessary for the gripper assembly to retrieve the mat, in one instance the mats are lifted approximately 10 inches. An index (117) located on the loading section allows to lift the mats sufficiently to be grabbed by the carriage system (17).

The PLC signals the carriage system to go pick up a mat. The carriage system (17) proceeds to the first end (20) of the washing system (1) and places itself substantially at a central position with respect to the mat (A) to be lifted and lowers the gripper assembly down towards the exposed edge of the mat. To create an unobstructed path, the infeed tips 3 degrees away from the lifted mat in both directions, allowing a 6 degree V-shaped opening. Once, the gripper assembly lifts the mat away and the mat proceeds into the wash chamber (25), the infeed returns to the vertical position. While the mat is away in the wash chamber, a scissor mechanism (127) pushes the remaining 5 mats over a position so the second mat in the stack is in position ready to be lifted.

Once the object has been gripped, the dual rack and pinion drives (117 and 117a) are actuated to lift the object prior to movement along the linear bearing function (21) frame. Once the object has gone through the washing system and is deemed clean, the object will be positioned at the second end (22) of the washing system (1) over the outfeed system (15) (also referred to as “unloading system”) where the rack and pinion drives will be actuated to move downwardly in order to have an edge of the object rest against the unloading system (15). As best seen in FIG. 7(B), when reaching the unloading system, the object will preferably rest upon an index (207). The index (207) is equipped with a horizontally moving clamp (205) which will subsequently move the object out of the way and against a main portion of the frame of the unloading system (15).

Once the object is in vertical position, the transport system (11) will lift each object one at a time and transport them through the washing system (1) and will unload them at the other end of the washing system in an unloading section (15). The transport system (11) comprises: a linear bearing function (21) and a carriage system (17) which travels from a first position (20) proximate the loading system (13) to a second position (22) proximate the unloading system (15). The carriage system (17) preferably comprises a lower carriage member (19) having clamps (123) which grip the objects on opposite surfaces. Pistons (125) are operatively connected to the gripper clamps (123) and the body of the lower carriage member (19). A rack and pinion drive (117), located on the carriage system (17) and in operative connection to a gripper clamp frame also referred to as lower carriage member (19), is extended downwardly towards the object to be lifted and positions the gripper clamp assemblies (123) on either side of the object, the gripper clamps (123) are then actuated and closed securely on the objet. The rack and pinion drive (117) is actuated to lift the object off of the loading section (13) and secure it in a transport position where the rack and pinion drive (117) is in a substantially non-extended position. Once the rack and pinion drive (117) is set back to a transport position, the carriage system (17) proceeds to travel down the transport system towards the washing section of the system.

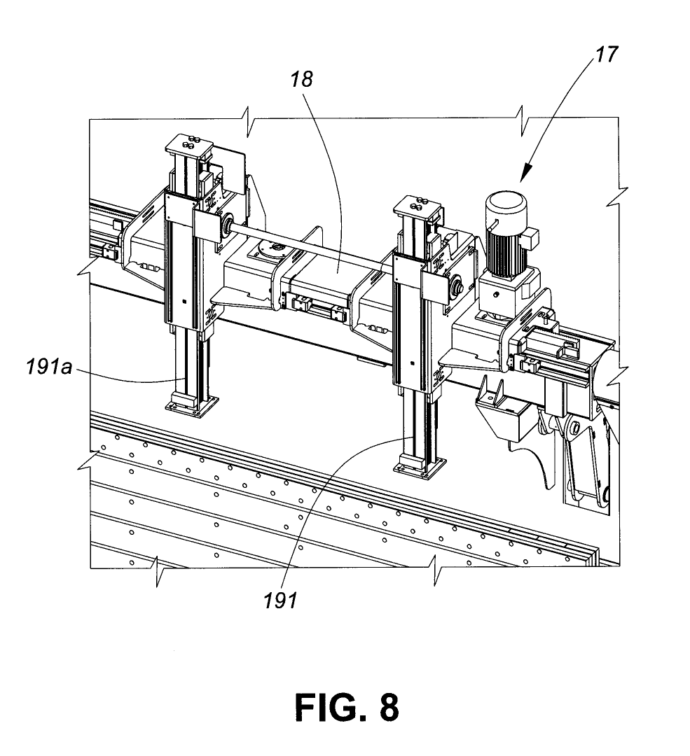

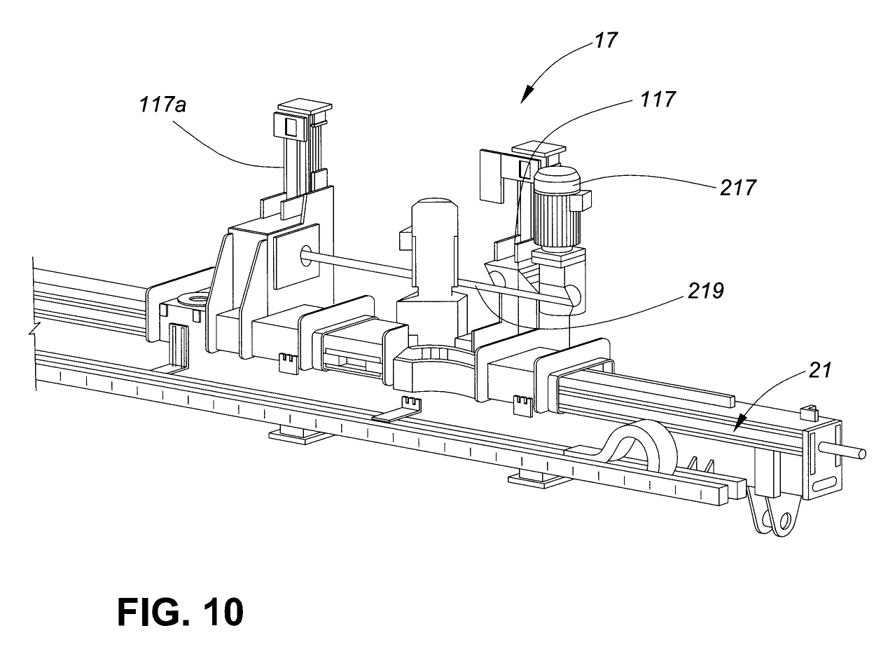

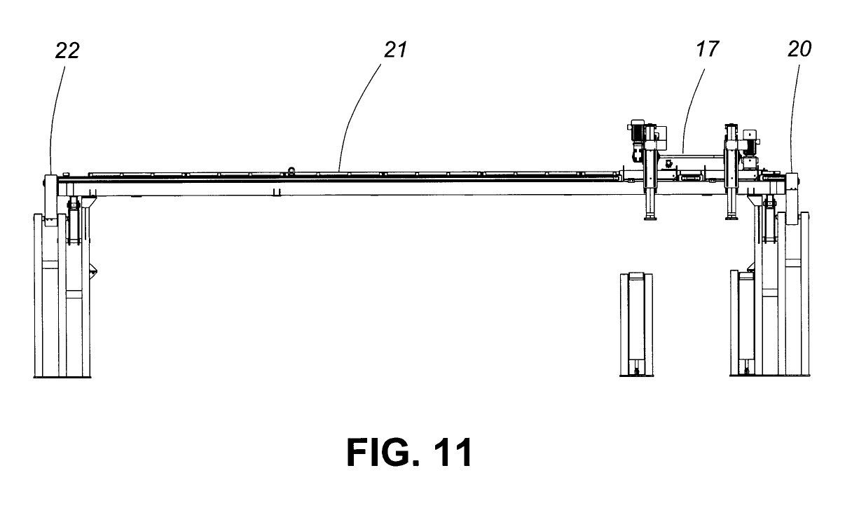

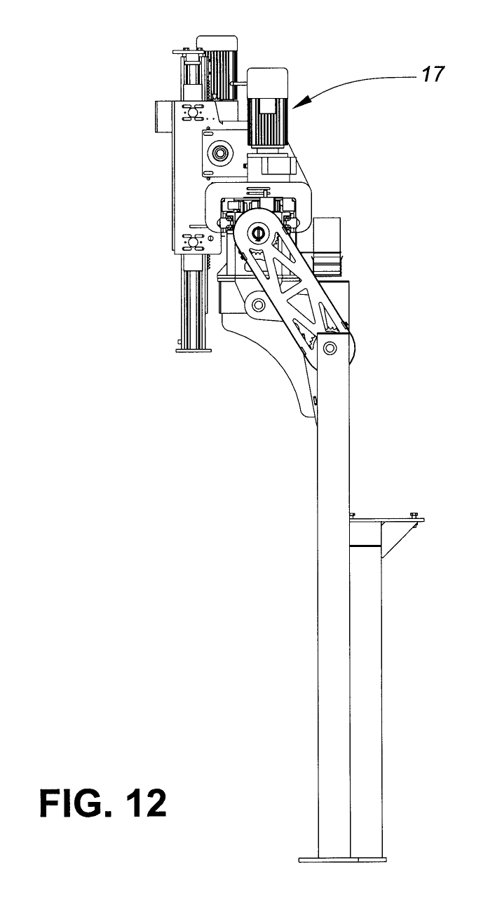

As best seen in FIGS. 8, 10, 11 and 12, the carriage system (17) comprises a carriage main body (18) operatively connected to the linear bearing function (21) for movement along the linear bearing from a first position at the first end (20) of the washing system (1) to a second position (22) at the second end of the washing system.

In the illustrated embodiment, the carriage main body (18) comprises two rack and pinion (117 and 117a) mounted thereon and driven by a single motor (217). Preferably, the rack and pinions are mounted on the same side of the carriage main body (18) so that they move two arms (191 and 191a) downward below the linear bearing function (21). The arms (191 and 191a) driven by the rack and pinion drives (117 and 117a) are connected to the lower carriage member (19) by a cylinder-receiving plate (193 and 193a). The lower carriage member (19) also referred to as the “gripper frame” is an elongated frame made up of two longitudinal frame bars (147 and 147a) secured to each other by the arm-receiving plates (193 and 193a). The lower carriage member (19), when in use, is intended to be positioned centrally to the object to be washed in order to provide sufficient support and stability to the object as it goes through the washing system. The lower carriage member (19) comprises at both extremities (24 and 26) a gripper clamp assembly (23 and 23a).

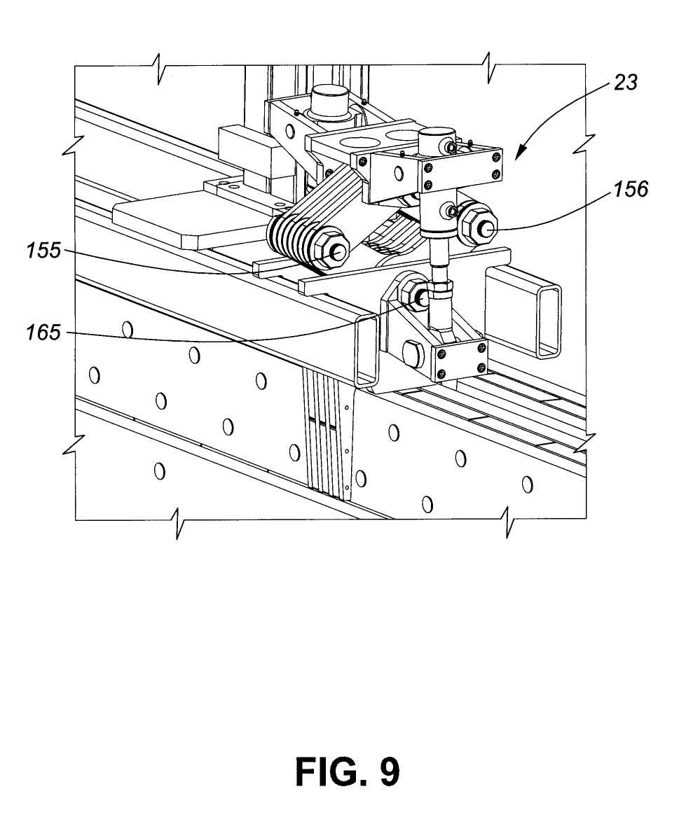

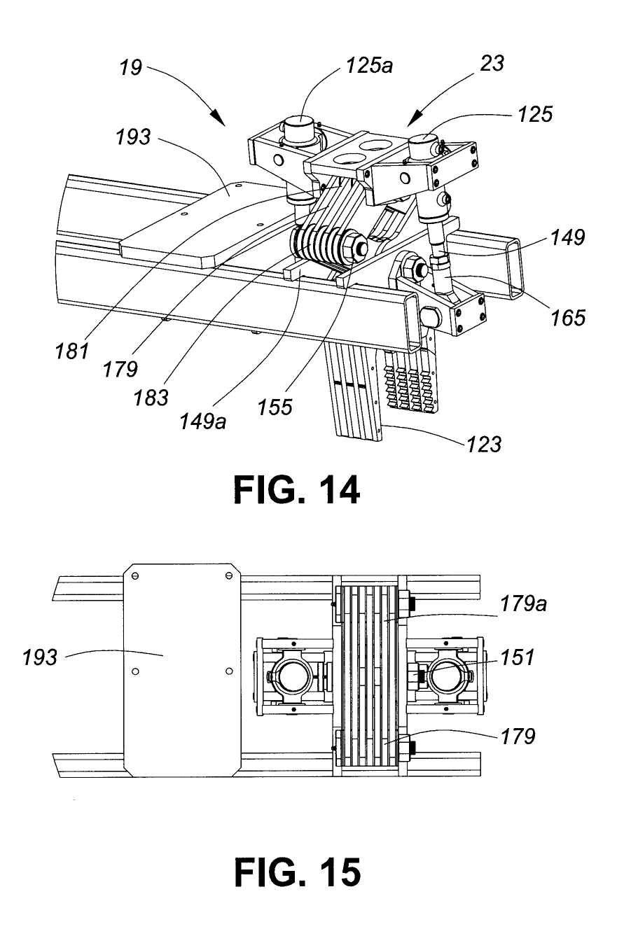

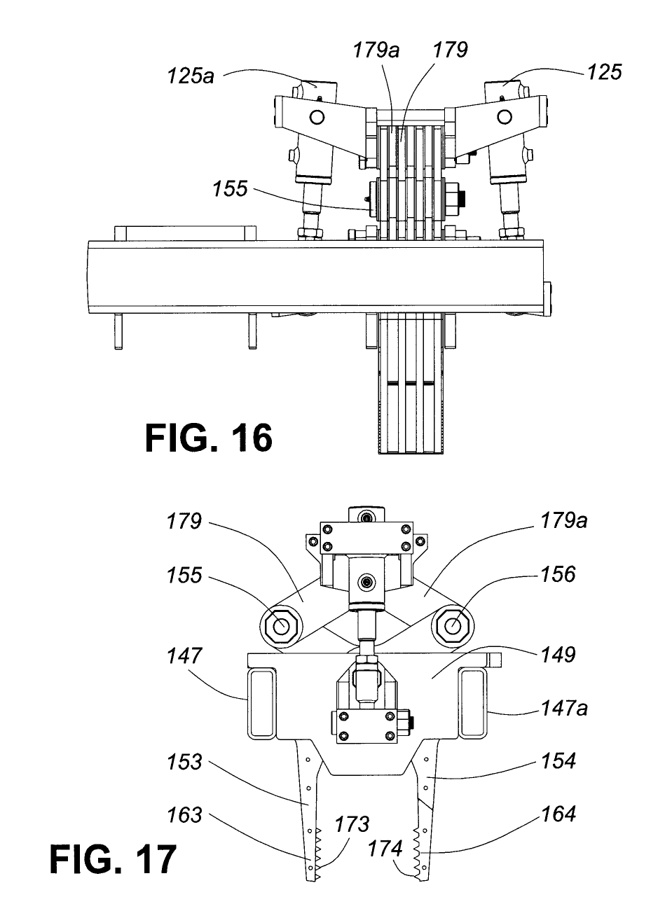

As seen in FIGS. 9, 13, 14, 15, 16 and 17, each gripper clamp assembly (23 and 23a) has two hydraulic cylinders (125 and 125a) to actuate the opening and closing motion of the gripper clamp (123).

The hydraulic cylinders (125 and 125a) are easily replaceable to allow for quick maintenance and short shut down times. The hydraulic cylinders (125 and 125a) are secured on the elongated frame (143) by cross-bars (149 and 149a) which link each one of the longitudinal frame bars (147 and 147a) together.

Each cross-bar (149 and 149a) has an aperture therethrough aligned with one another and adapted to receive a main gripper pivot (165). Each gripper clamp assembly (123) has a first jaw (153) having a first gripping portion (163) and a second jaw (154) having a second gripping portion (164). First and second gripping portions (163 and 164) include respective first and second inner gripping surfaces (173 and 174), which face inwardly towards each other.

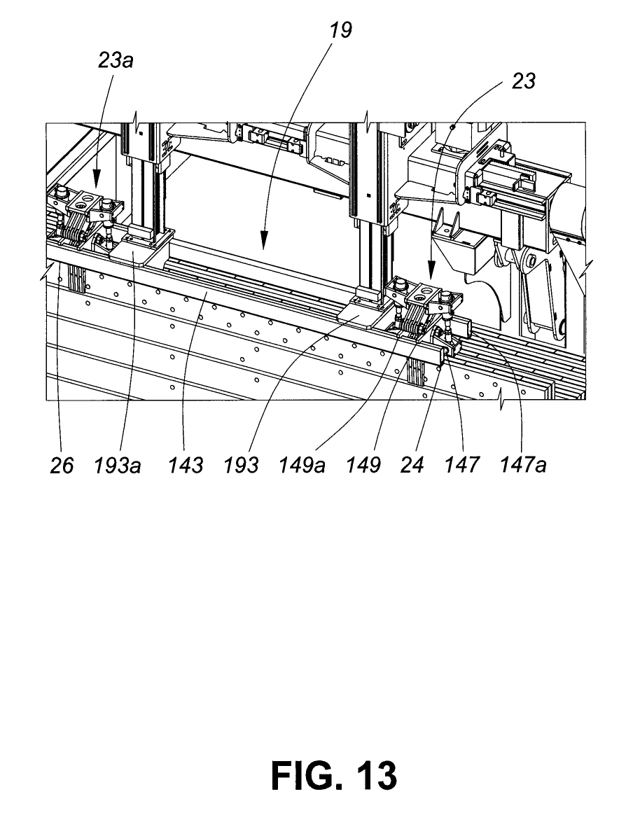

In the preferred embodiment of the present invention as illustrated in FIGS. 13, 14, 15, 16 and 17, the jaws are operatively connected to a pair of hydraulic cylinders which move in unison to open and close opposing first and second jaw to allow the gripping and releasing of objects. The hydraulic cylinders (125 and 125a) are positioned opposite one another and are pivotally connected to a first extremity (181) of a first set of tendons (179 and 179a) interposed between one another. The second extremity (183) of these tendons (179 and 179a) are connected to either a first secondary pivot point (155) or a second secondary pivot point (156). At the first secondary pivot point (155), the first set of tendons (179) are further pivotally connected a first set of lower tendons (154). The first set of lower tendons (154) comprises a gripper portion (164) at one end and an aperture (not shown) at the other end adapted to allow for pivotal connection with the first set of tendons (179). The second set of lower tendons (153) is further pivotally attached at the main gripper pivot point (165) also referred to as the “primary pivot point” located between the secondary pivot points (155 and 156) and the gripper portions (163 and 164) of the gripper clamp assembly (23). This main gripper pivot point (165) accommodates the lower set of tendons (153 and 154) coming from both the first secondary pivot point (155) and the second secondary pivot point (156) in such a way that the secondary tendons from both sides are staggered between one another. The tendons are interposed or staggered between one another to allow for greater strength of the gripper and a decreased tendency to warp. Each gripper is designed with multiple tendons.

The presence of multiple tendons creates a cumulative effective on the strength of the assembly and results in an extremely robust sealed and lubricated mechanism. The gripping surfaces (173 and 174) are hardened and replaceable. Preferably, the gripper clamps exert a force of 7,400 lbs per jaw for a total gripping force of nearly 30,000 lbs of pressure for a pair of gripper clamps. Each gripper clamps assembly has two hydraulic cylinders that are easily replaceable for quick maintenance. The actuation of the gripper clamp assemblies is part of the automated system and will be driven by the PLC. The strength of the gripper clamp assembly resides in large part in its lamination of several tendons and the staggered arrangement of the tendons making up the assembly.

The gripper clamp and its operation can be described as follows: upon actuation of the cylinders (23 and 23a) to create a downward movement thereof, the first set of tendons (179 and 179a) are pivotally moved around primary pivot (151) in a position such that the first secondary pivot point (155) and the second secondary pivot point (156) are displaced away from one another. This displacement translates into the displacement of the two sets of lower tendons (153 and 154) away from one another because of their rotation away from one another around the main gripper pivot point (165). Upon actuation of the cylinders where the cylinders (125 and 125a) move upwardly, the movement is reversed and the first sets of tendons (179 and 179a) are displaced in a position as to move the first secondary pivot point (155) and the second secondary pivot point (156) towards one another. This, in turn, translates into the displacement of the two sets of lower tendons (153 and 154) towards one another because of their rotation towards one another around the main gripper pivot point (156).

In a preferred embodiment, the actuation of the gripper clamp is part of the automated system and is controlled by the PLC.

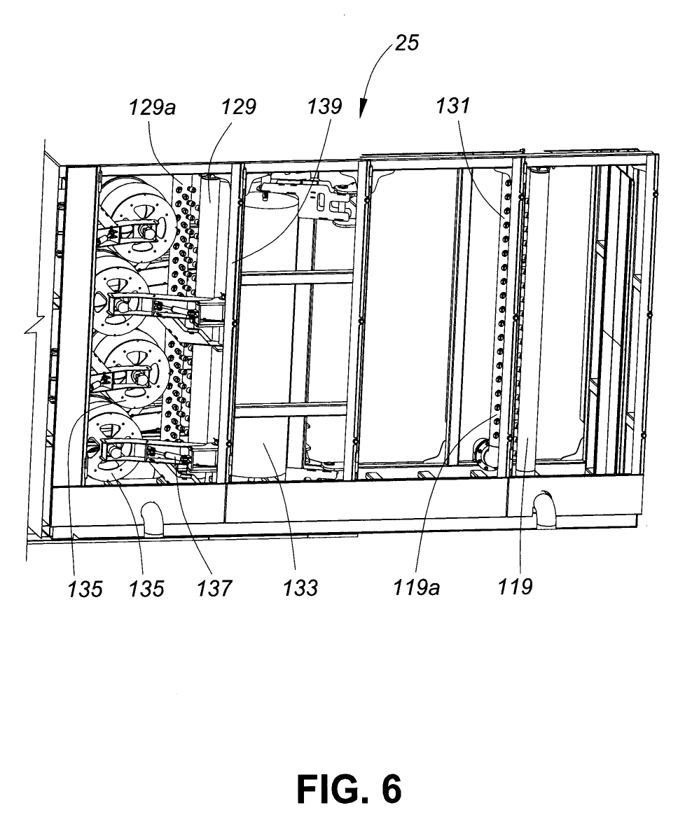

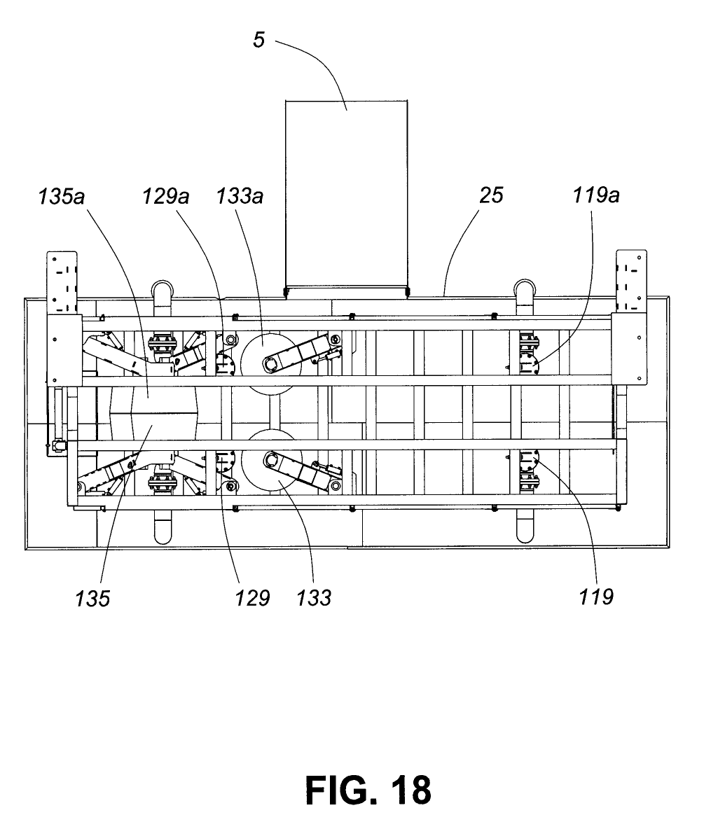

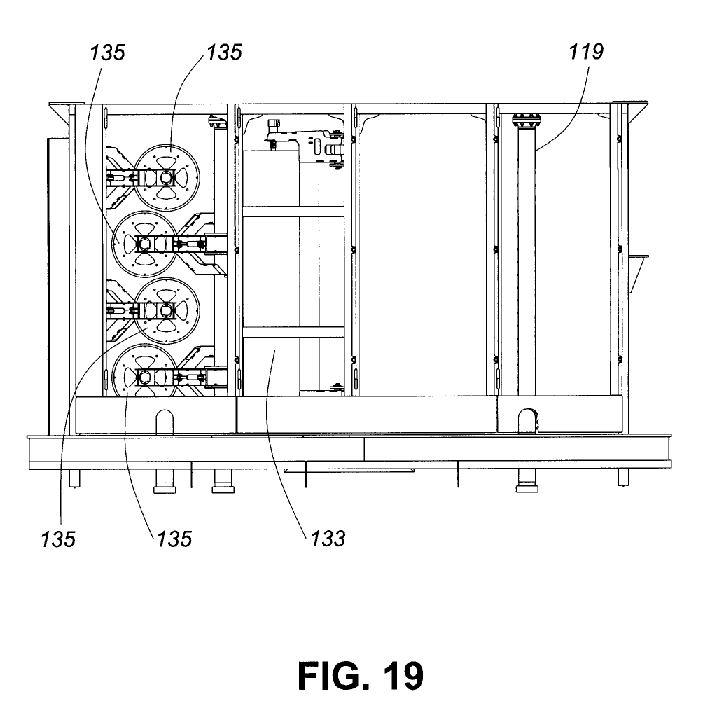

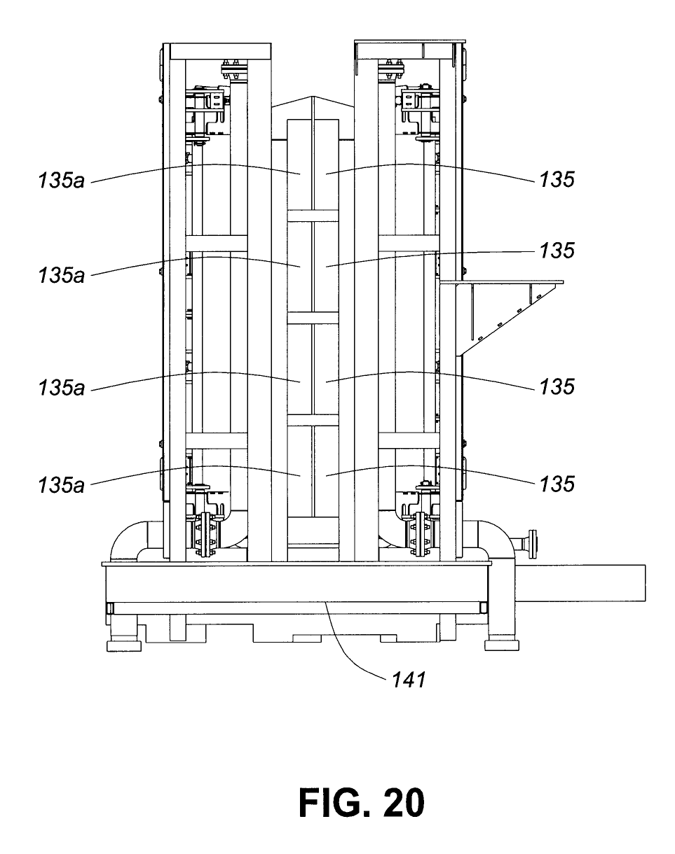

In a preferred embodiment, the linear bearing drive has an overall length of 48 feet, with a travelling length for the carriage system of approximately 38 feet. The transport system can be lowered within the frame of the washing system in order to adhere to road height allowances. All components are galvanized and the linear bearings, bearing surfaces (rolling and stationary) are hardened. In a preferred embodiment, the carriage system has a speed ranging between 0-4 feet per second during the washing phase and up to 7 feet per second on the carriage return. The carriage system has, according to a preferred embodiment, a 10 HP motor, a vector drive control with encoder positioning, and brakes which are actuated when motor power is off. There can also be inductive sensors which send feedback to control system for actuating all functions as the transport system is moving. In referring to FIGS. 6, 18, 19 and 20, the washing section comprises a wash chamber (25) which comprises a significant number of nozzles (131) from which water is sprayed onto the mats. In a preferred embodiment, there are 224 nozzles which spray the entire surface of the mat (A) at a pressure of up to 100 psi. Preferably, the nozzles (131) are located at the groove height, overspray and overlap on the board surfaces. In the illustrated embodiment, the washing section is a wash chamber which comprises two sets of brushes. The first set of brushes vertical cylindrical brushes (133 and 133a) designed to horizontally scrub the board surfaces and also address the spaces between the boards. The second set of brushes are conical brushes (135 and 135a), also referred to as conical “street sweeper-type” gutter brushes, which are actuated by a hydraulic cylinder (137) located on the arm (139) which connects the brush (137) to the wash chamber frame (139). The brushes (135) are pressed up against the mat (A) and are designed to scrub it vertically. The actuation as well as the pressure exerted by the cylinders (137) is controlled by the PLC. The combined action of the two sets of brushes allows scrubbing the mats both vertically and horizontally. The brushes are driven by hydraulic motors that are also actuated and driven by the PLC. The brush pressures exerted on the mats are controlled by hydraulic cylinders oriented horizontally to press the brushes against the mat.

Once the mat has been brushed by each pair of brushes, the latter separate to allow for an incoming mat to be brought in position. Preferably, there are bristle type splash guards located around the openings of the wash chamber. Preferably as well, there is rubberized canvas which surrounds the washing chamber frame (139) and directs water into a water collecting means which is preferably a channel or trough (141). The rubberized canvas surround is easily removable for cleaning any debris that collects on mechanical systems and collectors.

Preferably, hydraulic drives are directly connected to brushes, eliminating the need for chains or belts. The water and debris removed from the mats are collected by an underneath channel also referred to as a trough (141) located along the path of the mats and funneled to the first stage of the settling tank system (5).

In the illustrated embodiment as shown in FIGS. 6, 18, 19 and 20, the washing section (25) comprises a water spraying device (129) which in the figures is shown as two pairs of spray towers (119 and 119a) and (129 and 129a), a pair of vertically shafted cylindrical brushes (133) and a set of horizontally shafted gutter brushes (135). Water is sprayed onto the object travelling through a low pressure and high volume, once sprayed the object continues to travel first through a pair of cylindrical brushes (133) and then through a plurality of horizontally shafted gutter brushes (135). The horizontally shafted gutter brushes (135) are set on both sides of the axis along which the object to be washed travels. The horizontally shafted gutter brushes (135) are positioned in a staggered fashion and are also positioned in order to ensure that the entire surface of the object to be washed is brushed in a single pass. Optionally, the object is then subjected to another water spray intended to wash off the surfaces of the objects prior to reaching the unloading section (15) of the washing system (1).

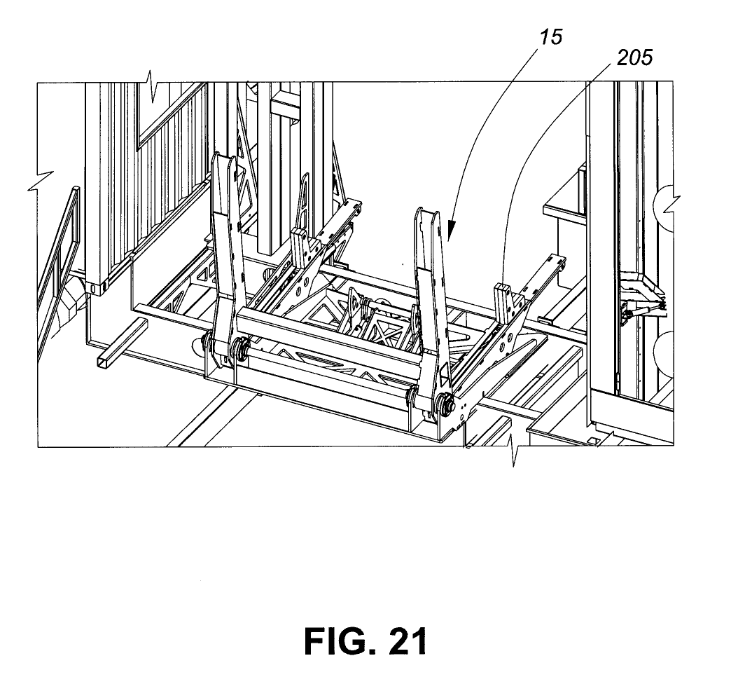

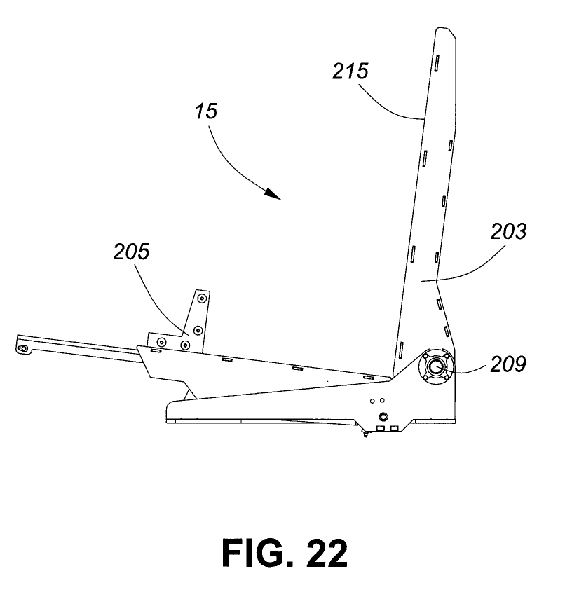

At the unloading section (15) as best seen in FIGS. 21 and 22, the dual rack and pinion drives from the carriage member extend downwardly sufficiently to rest the bottom edge of the object onto the object-receiving surface which is the index (207) located on the unloading system (15). After which the gripper clamps are spread apart and release the objet. The dual rack and pinion drive then moves the arms (191 and 191a) upwardly back into position prior to the carriage system (17) travelling back to the first end (20) of the washing system (1).

The unloading system (15) comprises an L-shaped frame (203) pivotally movable about an axis (209) to displace the object from a substantially vertical position to a substantially horizontal position where an unloader such as a forklift may remove the object from the unloading system (15).

Preferably, infeed (13) and outfeed (15) systems are coordinated to allow the last mat to be washed while the infeed system is being reloaded.

According to a preferred embodiment of the present invention, the device for washing large flat objects recycles the water used in the washing of the mats and can be operated in remote areas without reliance on a fixed & unlimited water source or utility. This feature is not known to be part of known mat washing devices and limits their use in locations where large volume of water.

Known systems require additional transporting system to load and unload mats. According to a preferred embodiment of the present invention, the device for washing large flat objects has loading and unloading capabilities which may be integral to the entire system and designed to automatically work with the entire system. There are no add-ons required. The loading & unloading system is novel to the industry as the loading portion takes a mat from a horizontal position to a vertical to wash it and reverses clean mats to unload them from the system.

The terms and descriptions used herein are set forth by way of illustration only and are not meant as limitations unless otherwise specifically indicated. Those skilled in the art will recognize that many variations are possible within the scope of the invention as defined in the following claims, and their equivalents, in which all terms are to be understood in their broadest possible sense unless otherwise specifically indicated. While the system shown and described in detail herein is fully capable of attaining the above-described aspects of the invention, the persons skilled in the art will understand that it is but a preferred embodiment of the present invention and the invention is not to be limited to that singular embodiment.

1. A system for washing a large flat object having a length and a width, wherein the length is of greater dimension than said width, said system comprising:
a frame having a first and second end;
a transport system secured to the frame and adapted to vertically transport said large flat object suspended thereon; said transport system having a longitudinal frame member defining a horizontal axis along the device and adapted to transport said object from the first end of the frame to the second end of the frame; and
at least one brushing means for brushing and removing particles lodged on said object;
said at least one brushing means located along the transport system between the first and second end of the frame and adapted to frictionally engage said object when in operation.

2. The system according to claim 1, wherein the at least one brushing means comprises a variable resistance means adapted to impart variable pressure on the object.

3. The system according to claim 1, wherein the large flat object is hung from its side.

4. (canceled)

5. (canceled)

6. The system according to claim 1, further comprising a loading support located at the first end of the frame, said loading support adapted to receive a plurality of objects to be washed wherein the loading support is adapted to move from a horizontal position to a vertical position.

7. (canceled)

8. The system according to claim 1, further comprising an unloading support located at the second end of the frame to receive the washed object.

9. The system according to claim 1, further comprising an unloading support located at the second end of the frame to receive the washed object wherein the unloading support comprises an index with a horizontally moving clamp.

10. The system according to claim 1, further comprising an unloading support located at the second end of the frame to receive the washed object wherein the unloading support comprises an L-shaped frame pivotally movable about an axis to move from a substantially vertical position to a substantially horizontal position.

11. The system according to claim 1, wherein the at least one brushing means is adapted to brush the entire height of the object.

12. The system according to claim 1, wherein the at least one brushing means is adapted to brush both sides of the large flat object simultaneously.

13. The system according to claim 1, further comprising at least one water source adapted to strike the object when such is being transported.

14. The system according to claim 1, further comprising at least one water source adapted to strike the object and said water source being located proximate before the at least one brushing means.

15. The system according to claim 1, further comprises a second brushing means which is a horizontally-shafted conical gutter brush.

16. The system according to claim 1, wherein the at least one brushing means is a fiber brush system comprising:
a. a vertical drum located on either side of the transport system horizontal axis, said vertical drum having brush fibers extending outwardly therefrom;
b. a lower bearing assembly engaging said vertical drum; and
c. a drive motor comprising an upper bearing assembly engaging said vertical drum;
wherein said vertical drum being movable from a first position away from the horizontal axis defined by the longitudinal frame member of the transport system to a second position proximate the horizontal axis.

17. The system according to claim 1, further comprising at least one water source adapted to spray water on the object and said water source being located proximate the second end of the frame after the at least one brushing means.

18. The system according to claim 1, further comprising at least one water source adapted to strike the object and said water source being located proximate the first end of the frame after the at least one brushing means.

19. The system according to claim 1, further comprising at least one water source adapted to spray water on the object and said water source being located proximate the first end of the frame before the at least one brushing means.

20. The system according to claim 1, further comprising at least one water collecting means to collect water used in washing the object.

21. (canceled)

22. (canceled)

23. (canceled)

24. The system according to claim 1, wherein the transport system comprises: a carriage
member comprising at least one pair of gripping members adapted to grip the object and maintain it off the ground while the object is being transported from the first position to the second position; and
a linear roller bearing assembly mounted adapted to allow for the carriage member to move between a first position located at the first end of the frame and a second position located at the second end of the frame.

25. A system for washing a large flat object having a length and a width, wherein the length is of greater dimension than said width, said system comprising:
a frame having a first and second end;
a transport system adapted to vertically transport said large flat object suspended thereon; said transport system comprising a linear bearing assembly extending from the first end of the washing system to the second end of the washing system, said transport system adapted to transport said object from the first end of the frame to the second end of the frame; and at least one brushing means adapted for brushing vertically said object;
said at least one brushing means located underneath the linear bearing assembly along the transport system between the first and second end of the frame.

26. A system according to claim 25 further comprising a second brushing means adapted for brushing horizontally said object; said second brushing means is located underneath the longitudinal frame member of the transport system between the first and second end of the frame.

27. (canceled)

28. (canceled)

29. (canceled)

30. (canceled)

31. (canceled)

32. (canceled)

33. (canceled)

34. (canceled)

35. A system for washing a large flat object having a length and a width, wherein the length is of greater dimension than said width, said system comprising:
a frame having a first and second end; a transport system adapted to vertically transport said large flat object suspended thereon; said transport system defining a horizontal axis along the device and adapted to transport said object from the first end of the frame to the second end of the frame; and
a first and a second set of brushing means for brushing and removing particles lodged on said object; wherein said first and second set of brushing means are adapted to have a perpendicular brushing impact motion on the object with respect to the brushing impact caused by one another.

36. (canceled)

37. (canceled)
